(19) United States
(12) Patent Application Publication
(10) Pub. No.: US 2026/0233776 A1
(43) Pub. Date: Aug. 13, 2026

(54) TIGHTENING DEVICE FOR A STEERING COLUMN, AND STEERING COLUMN FOR A MOTOR VEHICLE

(71) Applicants: thyssenkrupp Presta AG, Eschen (LI); thyssenkrupp AG, Essen (DE)

(72) Inventors: Christoph JEHLE, Nesslau (CH); Florian DEIGL, Feldkirch (AT)

(73) Assignees: thyssenkrupp Presta AG, Eschen (LI); thyssenkrupp AG, Essen (DE)

(21) Appl. No.: 19/538,669

(22) Filed: Feb. 12, 2026

(30) Foreign Application Priority Data
Feb. 13, 2025 (DE) 10 2025 105 359.6

(51) Int. Cl. B62D 1/19; B62D 1/16; B62D 1/181; B62D 1/183; B62D 1/185; B62D 1/187; B62D 1/189

(52) U.S. Cl. CPC B62D 1/195; B62D 1/16; B62D 1/181; B62D 1/183; B62D 1/185; B62D 1/187; B62D 1/189

(57) ABSTRACT

A tightening device for a steering column of a motor vehicle comprises a tightening bolt, axially extended in the direction of a tightening axis, and a tightening lever which is connected in torsion-locked manner to the tightening bolt via a coupling element and a connecting element, wherein the coupling element exhibits an axially protruding first projection and an axially protruding second projection, radially opposing the first projection with respect to the tightening axis, and the connecting element exhibits a first aperture in which the first projection engages axially, and exhibits a second aperture in which the second projection engages axially and which has been designed to be open radially outward. In order to make possible a more compact structure and improved manufacture, the second projection may have a radial second-projection width that is larger than a radial first-aperture width of the first aperture, and that is larger than a radial second-aperture width of the second aperture.

### CROSS REFERENCE TO RELATED APPLICATION

This application is a U.S. Non-Provisional that claims priority to German Patent Application No. DE 10 2025 105 359.6, filed Feb. 13, 2025, the entire content of which is incorporated herein by reference.

### FIELD

The present disclosure relates to tightening device for a steering column of a motor vehicle.

### BACKGROUND

For the purpose of adapting the position of the steering wheel, which is attached to the rear end of the steering spindle with respect to the direction of travel, to the driver's position in the case of an adjustable steering column, it is known to adjust the servo unit, in which the steering spindle is mounted, relative to the supporting unit which is fixed with respect to the body.

By means of a generic tightening device, which can be brought optionally into a fixing position (clamping position) or into a disengaging position, the servo unit can be disengageably wedged in relative to the supporting unit. In the normal driving mode, in the fixing position the servo unit has been fixed relative to the supporting unit, and in the disengaging position the servo unit can be adjusted relative to the supporting unit for the purpose of setting the steering-wheel position. For the purpose of alternating between the disengaging position and the fixing position, a tightening bolt, interacting with a reciprocating device, of the tightening device can be rotated about its axis by actuation of a tightening lever connected in torsion-locked manner to said tightening bolt. Actuation can preferably be effected manually.

For the torsion-locked connection of the tightening lever to the tightening bolt, from EP 3 272 623 B1 it is known to couple a connecting element with a coupling element in torsion-locked manner. In this case, the connecting element may have been connected to the tightening lever, and the coupling element may have been connected to the tightening bolt, or the other way around. These two alternatives are covered in the following, even though only the attachment of the connecting element to the tightening lever is mentioned.

For the purpose of generating the torsion-locked connection, the coupling element exhibits an axially protruding first projection and a likewise axially protruding second projection, parallel to the first projection, radially opposing the first projection with respect to the axis. The two projections are arranged in the form of a cam on the front side facing toward the connecting element of the tightening lever. The connecting element exhibits a first axial aperture on its front side facing toward the coupling element, in which the first projection engages for the purpose of forming a positive closure which is effective in the circumferential direction, and a second axial aperture in which the second projection engages for the purpose of forming a positive closure which is effective in the circumferential direction.

In order to enable a balancing of tolerances between the two projections and the assigned apertures, in the aforementioned EP 3 272 623 B1 it is proposed that the second aperture, measured in the radial direction, has a second-aperture width that is larger than a second-projection width, likewise measured in the radial direction, of the second projection. As a result, a secure positive engagement of both projections can be made possible by means of a relatively simple assembly. However, it is regarded as disadvantageous that the realization of the enlarged aperture width requires a relatively large dimension of the connecting element. In addition, the manufacturing effort is increased by virtue of the fact that the connecting element can be positively connected to the coupling element in two assembly positions rotated by 180°, so that an elaborate monitoring of the correct assembly is required.

Thus a need exists to make possible a more compact structure and improved manufacture.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a steering column according to the invention in a schematic perspective view.

FIG. 2 shows an enlarged detailed view of the steering column according to FIG. 1.

FIG. 3 shows an enlarged detailed view of the tightening device according to the invention according to FIG. 2.

FIG. 4 shows a partial view of the tightening device according to FIG. 3.

FIG. 5 shows an enlarged axial view of the tightening device according to FIGS. 2 to 4.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure relates to a tightening device for a steering column of a motor vehicle, including a tightening bolt, axially extended in the direction of a tightening axis, and a tightening lever which is connected in torsion-locked manner to the tightening bolt via a coupling element and a connecting element, wherein the coupling element exhibits an axially protruding first projection and an axially protruding second projection, radially opposing the first projection with respect to the tightening axis, and the connecting element exhibits a first aperture in which the first projection engages axially, and exhibits a second aperture in which the second projection engages axially and which has been designed to be open radially outward. A steering column with a tightening device of such a type is likewise a subject of the invention.

In the case of a tightening device for a steering column of a motor vehicle, including a tightening bolt, axially extended in the direction of a tightening axis, and a tightening lever which is connected in torsion-locked manner to the tightening bolt via a coupling element and a connecting element, wherein the coupling element exhibits an axially protruding first projection and an axially protruding second projection radially opposing the first projection with respect to the tightening axis, and the connecting element exhibits a first aperture in which the first projection engages axially, and exhibits a second aperture in which the second projection engages axially and which has been designed to be open radially outward, in accordance with the invention there is provision that the second projection has a radial second-projection width that is larger than a radial first-aperture width of the first aperture, and that is larger than a radial second-aperture width of the second aperture.

The term “radial second-projection width” denotes the radial dimension of the second projection or, in other words, the dimension of the cross-section, measured with respect to the axis in the radial direction, of the second projection.

The first aperture has been designed to be closed-that is to say, it has an aperture cross-section delimited over its entire circumference by a peripheral, closed inner wall. The term “radial first-aperture width” denotes the radial dimension of the aperture cross-section of the first aperture, measured in the radial direction.

The second aperture is open radially outward-that is to say, its aperture cross-section is closed by its inner wall merely radially inward and in the circumferential direction with respect to the axis. In other words, the second aperture takes the form of a recess or notch which has been introduced radially from outside into the outer circumference of the connecting element. The term “radial second-aperture width” denotes the radial dimension of the aperture cross-section of the second aperture. This cross-section is measured in the radial direction from the radially internal inner wall of the aperture as far as the circumferential outer edges of the radially outward open aperture cross-section. The edges denote the transition between the radially inward and circumferentially closed inner wall of the second aperture and the outer circumference of the connecting element. Expressed otherwise, the radial second-aperture width corresponds to the depth, measured inward in the radial direction, of the second aperture introduced from outside as a recess or notch into the outer circumference of the connecting element. Correspondingly, this depth, or the radial second-aperture width, extends radially in the same direction as the radial second-projection width.

The second aperture may preferably take the form of a recess or notch—for instance, a substantially U-shaped recess or notch—introduced radially from outside into the connecting element.

One advantage of the invention is that the second projection protrudes in any case beyond the open circumferential portion of the second aperture radially outward beyond the outer circumference of the connecting element. By virtue of the radial width of the projection, which is larger relative to the depth of the aperture, a secure engagement for generating the positive closure which is effective in the circumferential direction is guaranteed. The correct assembly can be detected and monitored easily and reliably from outside by virtue of the fact that the second projection protrudes radially outward from the second aperture. This holds true, in particular, in the case of an automated inspection of the assembly—for example, by image-recognition—which is reliant upon unambiguously recognizable optical patterns and/or silhouettes.

A further advantage is that, by virtue of its larger radial dimension, the second projection cannot be inserted into the first aperture, which is relatively smaller radially. The first projection can be inserted into the first aperture, and the second projection can be inserted exclusively into the second aperture. As a result, an unambiguously defined orientation of the connecting element relative to the coupling element, and hence of the tightening lever relative to the tightening bolt, is specified. Accordingly, an incorrect assembly is ruled out, and manufacture is simplified.

For the purpose of introducing a manual actuating force, the tightening lever may—depending upon the design of the connecting element or of the coupling element—exhibit a radially protruding grasping part which can be swivelled about the axis by hand. Alternatively, it is conceivable and possible that the tightening lever is swivelled about the axis by means of a motorized drive apparatus.

It is preferred that the radial second-projection width of the second projection is larger than a radial first-projection width of the first projection. The first projection may preferably have been adapted as regards its radial projection width to the aperture width of the first aperture, and the second projection may have been correspondingly adapted to the second aperture. As a result, the orientation with respect to the axis is readily recognizable, and the unambiguous assignment in the course of assembly is simplified.

It is advantageous that the second projection has a radial second-projection width that is larger than its circumferential width. The term “circumferential width of the second projection”, also called the “second circumferential width” for short, denotes the dimension, measured in the circumferential direction, of the cross-section of the second projection. By virtue of its larger radial dimension in relation to said cross-section, the second projection has a non-circular cross-section that is elongated in the radial direction. One advantage of this configuration is that a relatively large radial clearance can be specified with respect to the simultaneous positive engagement of the two projections in the assigned apertures, for instance for the purpose of balancing tolerances or for a simplified assembly, and yet a secure engagement of the second projection in the second aperture, which is open outward, can be guaranteed in each case. Furthermore, the elongated cross-section in the radial direction is also an advantage with regard to the reliable recognition of the position and alignment of the assembled parts by an automated inspection of the assembly with the aid of image-recognition.

There may be provision that the radial second-aperture width of the second aperture is less than or equal to its circumferential width. The dimension, measured in the circumferential direction, of the second aperture in this case is equal in magnitude to, or less than, its depth, or radial aperture width, measured in the radial direction. As a result, it is possible to decrease the radial dimension of the connecting element on the tightening lever, and to realize an advantageously compact structure.

It is advantageous that the first projection has a radial first-projection width that is less than or equal to its circumferential width. The term “circumferential width of the first projection”, also called the “first circumferential width” for short, denotes the dimension, measured in the circumferential direction, of the cross-section of the first projection. This dimension may preferably correspond to the radial dimension of the projection, so that the first projection may preferably have a rotationally symmetrical cross-section, for instance a circular or polygonal cross-section.

In the aforementioned design, it is preferred that the radial first-aperture width of the first aperture is less than or equal to its circumferential width. The aperture cross-section may preferably have been adapted to the cross-section of the first projection, so that the latter can be fitted into the aperture with specified clearance. For instance, the aperture may have been adapted to the preferentially rotationally symmetrical projection and may, for instance, have been configured to be circular or polygonal. As a result, a space-saving structure is made possible, and the tolerance of the positive engagement can be defined by the clearance in the radial direction and in the circumferential direction.

There may preferentially be provision that the tightening lever exhibits the connecting element. In this case, the first and second apertures have been introduced into the tightening lever, and they correspond to the first and second projections on the coupling element connected to the tightening axis.

An advantageous development of the aforementioned design is that the connecting element has been formed in one piece with the tightening lever. This may have been realized by virtue of the fact that the apertures have been formed in integrated manner with a grasping element.

It is advantageous that the tightening lever exhibits a sheet-metal shaped part. The sheet-metal shaped part may have been manufactured efficiently by stamping, bending and/or pressing, inclusive of the connecting element, preferentially in one piece, preferably from sheet steel.

In an advantageous development, there may be provision that a reciprocating device which is operatively connected to the tightening bolt exhibits the coupling element. The reciprocating device has been designed to convert a rotation of the tightening bolt about its axis into an axial tightening stroke, and may exhibit, for instance, a wedge-disc, ball-ramp or tilt-pin mechanism or such like. Arrangements of such a type exhibit a functional part—for instance, a wedge disc, a supporting flange for tilt pins or such like—connected to the tightening bolt in torsion-resistant manner. Hence the coupling element according to the invention may preferably have been formed together, preferably in a one-piece form of construction. As a result, an advantageously compact style of construction can be realized.

The invention encompasses, moreover, a steering column for a motor vehicle, including a supporting unit, by which a servo unit is held in adjustable manner, and including a tightening device which exhibits a tightening bolt which is capable of being rotated about its tightening axis and which interacts with a reciprocating device which has been designed for disengageable bracing of the supporting unit with the servo unit by rotation of the tightening bolt which is connected in torsion-locked manner to a tightening lever via a coupling element and a connecting element, wherein in accordance with the invention there is provision that the tightening device has been formed in accordance with one of the designs described above, or combinations thereof.

The reciprocating device may have been designed, in a manner known as such, to convert a rotation of the tightening bolt about its axis into an axial tightening stroke, and may exhibit, for instance, a wedge-disc, ball-ramp or tilt-pin mechanism or such like. By virtue of the tightening stroke, side-pieces, for instance, of a supporting unit can be pressed together against one another and can be braced against the servo unit by force closure. In the normal driving mode, by virtue of the fact that the tightening device is in the fixing or clamping position, the servo unit has been fixed relative to the supporting unit, so that the steering-wheel position has been established. For the purpose of setting the steering-wheel position, the tightening device can be brought into the disengaging position by actuation of the tightening lever, as a result of which the bracing is terminated, and the servo unit can be adjusted relative to the holding unit into the desired steering-wheel position. By reverse actuation of the tightening lever, the setting can be fixed again.

For the purpose of height-adjustment, the servo unit may be capable of swivelling relative to the holding unit about a height-adjustment axis situated horizontally at right angles to the longitudinal axis. Alternatively, or in combination, a longitudinal adjustment may have been provided by virtue of the fact that the servo unit is telescopically adjustable in the longitudinal direction relative to the supporting unit.

In the various figures, identical parts have always been provided with the same reference symbols, and will therefore, as a rule, also each be named or mentioned only once.

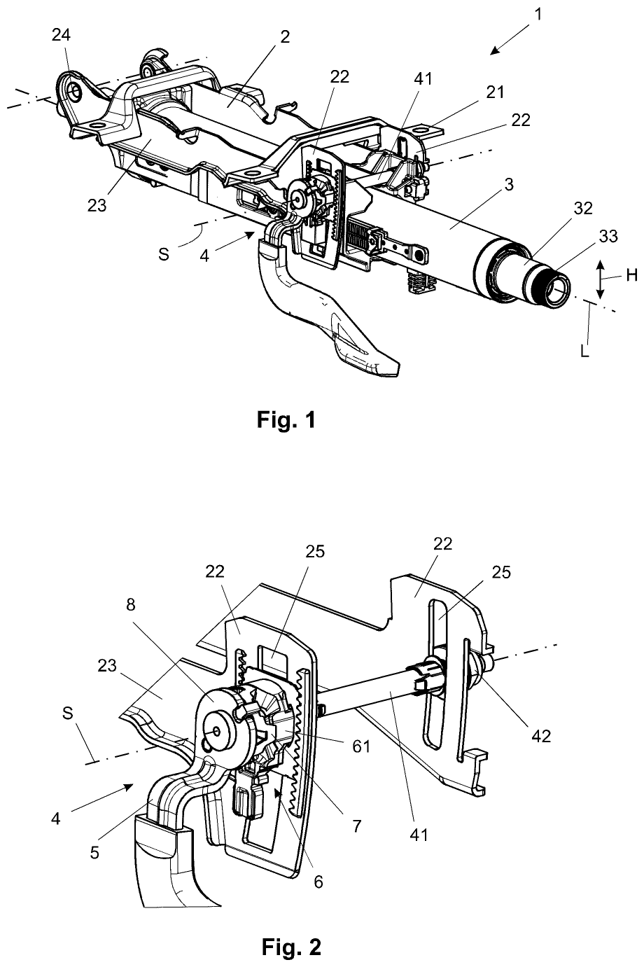

FIG. 1 shows in perspective view—obliquely from the left rear relative to the direction of travel of a motor vehicle, not shown here—a steering column 1 which exhibits a supporting unit 2. The latter includes fastening means 21—for instance, fastening apertures as represented—for connection to the body, not represented, of the motor vehicle. From the supporting unit 2 two opposing side-pieces 22 extend downward with respect to a longitudinal axis L.

A casing unit 23, which is also designated as an outer casing or guide box, is accommodated between the side-pieces 22.

A servo unit 3, which exhibits a steering spindle 32 mounted so as to be rotatable about its longitudinal axis L extended in the longitudinal direction, is accommodated in the casing unit 23. At the rear, driver's-side, end relative to the direction of travel, the steering spindle 32 exhibits a fastening section 33 for attachment of a steering wheel, not represented.

The servo unit 3 is accommodated in the casing unit 23 so as to be longitudinally displaceable in the longitudinal direction—that is to say, in the direction of the longitudinal axis L—as indicated schematically by a double-headed arrow.

The casing unit 23 is mounted so as to be capable of swivelling about a swivel axis 24, situated at right angles to the longitudinal axis L, on the supporting unit 2. As a result, the casing unit can be moved up and down in the height direction H together with the servo unit 3 for the purpose of setting the height position of the steering wheel between the side-pieces 22 relative to the supporting unit 2, by being swivelled about the swivel axis 24, as indicated by a double-headed arrow.

A tightening device 4 according to the invention has been designed to be brought optionally into a fixing position (tightening position) or into a disengaging position (release position). In the fixing position, the casing unit 23 has been wedged in between the side-pieces 22, and fixed to the supporting unit 2, and the servo unit 3 has been clamped in the casing unit 23 by virtue of the clamping applied via the side-pieces 22, and has thereby been fixed in the longitudinal direction. In the disengaging position, the casing unit 23 can be adjusted in the height direction H relative to the supporting unit 2, and the servo unit 3 can be adjusted in the longitudinal direction relative to the casing unit 23 and hence also relative to the supporting unit 2.

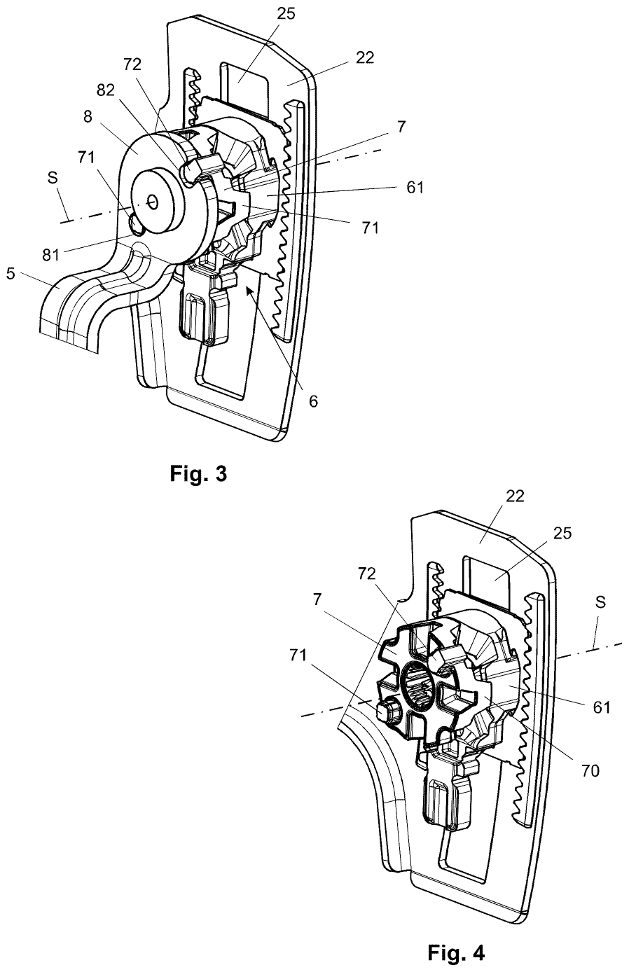

The tightening device 4 exhibits a tightening bolt 41 which extends along a tightening axis S situated at right angles to the longitudinal axis L through elongated holes 25, extended in the height direction, in both side-pieces 22 and through passage openings in the casing unit 23. In FIG. 2, the steering column 1 is represented in the region of the tightening device 4 in selectively enlarged manner without the servo unit 3 and the casing unit 23, and in FIG. 3 the tightening device is shown released in a separate view.

A tightening lever 5 is connected in torsion-resistant manner to the tightening bolt 41 at one end. A reciprocating device 6 is arranged between the tightening lever 5 and the side-piece 22 facing toward the tightening lever. On the other side-piece 22 the tightening bolt 41 is supported with respect to the longitudinal axis L from outside with the aid of an abutment 42, for instance a screwed-on nut.

In the example, the tightening device 4 takes the form of a cam-type linking-disc device or a wedge-disc device, and exhibits a cam disc 70, attached to the tightening bolt 41 in torsion-resistant manner, which has been formed in one piece together with the coupling element 7 according to the invention.

The cam disc 70 of the coupling element 7 interacts with a linking disc 61 mounted so as to be rotatable relative to the tightening bolt 41 and supported axially from outside against the side-piece 22. The cam disc exhibits cams protruding axially against the linking disc 61, which therein axially abut a linking track ascending in the circumferential direction, partially in the axial direction. As a result, in a manner known as such a reciprocating mechanism is formed which in the course of a rotation of the coupling element 7 with the cam disc together with the tightening bolt 41 generates a stroke directed axially in the direction of the tightening axis S, by virtue of which the two side-pieces 22 can be moved in relation to one another in order to brace the tightening unit 3 with the supporting unit 2 disengageably in the fixing position.

Alternatively, the tightening device 4 can generate another mechanism for generating an axial tightening stroke by rotation of the tightening bolt 41—for instance, a tilt-pin or ball-ramp arrangement or such like. In this case, a functional element which is capable of being rotated together with the tightening bolt likewise takes the form of a coupling element 7.

The tightening lever 5 exhibits a connecting element 8 which, in accordance with the invention, interacts with the coupling element 7. The functionality is elucidated below with reference to the enlarged detailed representations shown in FIGS. 3 to 5.

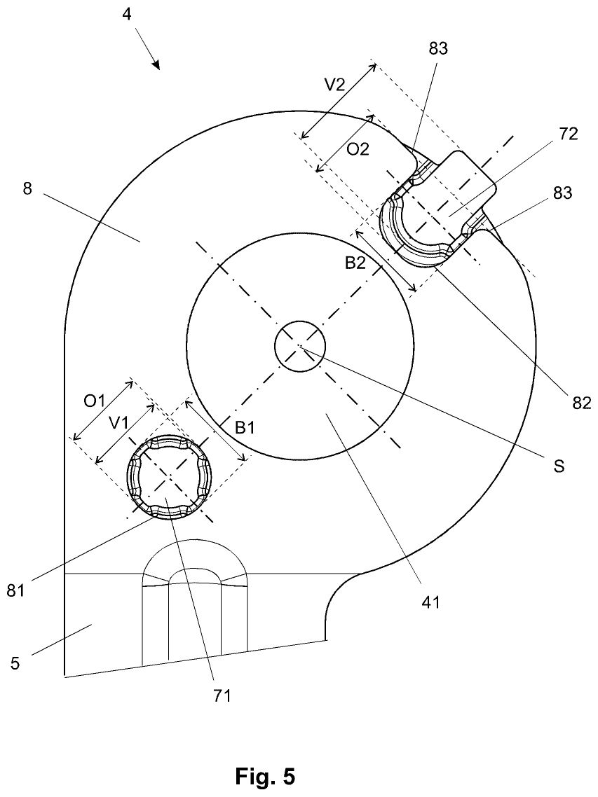

The coupling element 7 is attached in torsion-resistant manner to the outer end of the tightening bolt 41, and exhibits an axially protruding first projection 71 and a second projection 72 arranged radially opposing the first projection with respect to the tightening axis S. The first projection 71 has a substantially circular or at least rotationally symmetrical cross-section with a radial first-projection width V1, measured from the tightening axis S in the radial direction, and with a first circumferential width B1, measured in the circumferential direction. As in the example shown, V1 is preferably equal to B1. The second projection 72 is elongated in the radial direction with a radial second-projection width V2 and with a second circumferential width B2, measured in the circumferential direction, where V2>B2 may preferably hold, as in the example. This is discernible in the enlarged view shown in FIG. 5.

The connecting element 8 exhibits a first aperture 81, into which the first projection 71 has been axially inserted. The first aperture 81 has an aperture cross-section adapted to the cross-section of the first projection 71, with a radial first-aperture width O1. The first aperture 81 has been designed to be closed on all sides—that is to say, it encloses the first projection 71 peripherally over the entire circumference thereof.

The connecting element 8 exhibits a second aperture 82, into which the second projection 72 has been axially inserted. The second aperture 82 takes the form of a substantially U-shaped recess or notch which has been introduced radially from outside into the outer circumference of the connecting element 8. Correspondingly, the second aperture 82 is open on its circumference directed radially outward. The second aperture has a radial second-aperture width O2. This width is measured in the radial direction from the radially internal inner wall of the aperture as far as the circumferential outer edges 83 of the aperture cross-section, open radially outward. The edges 83 designate the transition between the radially inward and circumferentially closed inner wall of the second aperture 82 and the outer circumference of the connecting element 8. Expressed otherwise, the radial second-aperture width O2 corresponds to the depth, measured inward in the radial direction, of the second aperture 82 introduced from outside as a recess or notch into the outer circumference of the connecting element 8. Correspondingly, this depth, or the radial second-aperture width O2, extends radially in the same direction as the second-projection width V2.

The circumferential width, measured in the circumferential direction, of the second aperture 82 has been adapted to the second circumferential width B2 of the second projection 72, so that in the circumferential direction a relatively small clearance has been formed which may preferably correspond approximately to the clearance in the circumferential direction between the first projection 71 and the first aperture 81.

According to the invention, the radial second-projection width V2 of the second projection 72 is larger than the radial first-aperture width O1 of the first aperture 81, and also larger than the radial second-aperture width O2 of the second aperture 82.

### LIST OF REFERENCE SYMBOLS

1 steering column
2 supporting unit
21 fastening means
22 side-pieces
23 casing unit
24 swivel axis
25 elongated hole
3 servo unit
32 steering spindle
33 fastening section
4 tightening device
41 tightening bolt
42 abutment
5 tightening lever
6 reciprocating device
61 linking disc
7 coupling element
70 cam disc
71 first projection
72 second projection
8 connecting element
81 first aperture
82 second aperture
83 edge
L longitudinal axis
H height direction
S tightening axis
V1 radial first-projection width
V2 radial second-projection width
B1 first circumferential width
B2 second circumferential width
O1 radial first-aperture width
O2 radial second-aperture width

1. A tightening device for a steering column of a motor vehicle, comprising:
a tightening bolt, axially extended in a direction of a tightening axis; and
a tightening lever which is connected in torsion-locked manner to the tightening bolt via a coupling element and a connecting element;
wherein the coupling element exhibits an axially-protruding first projection and an axially-protruding second projection, radially opposing the first projection with respect to the tightening axis, and the connecting element exhibits a first aperture in which the first projection engages axially, and exhibits a second aperture in which the second projection engages axially and which has been designed to be open radially outward;
wherein the second projection has a radial second-projection width that is larger than a radial first-aperture width of the first aperture, and that is larger than a radial second-aperture width of the second aperture.

2. The tightening device according to claim 1, wherein the radial second-projection width of the second projection is larger than a radial first-projection width of the first projection.

3. The tightening device according to claim 1, wherein the second projection has a radial second-projection width that is larger than its circumferential width.

4. The tightening device according to claim 1, wherein the radial second-aperture width of the second aperture is less than or equal to its circumferential width.

5. The tightening device according to claim 1, wherein the first projection has a radial first-projection width that is less than or equal to its circumferential width.

6. The tightening device according to claim 1, wherein the radial first-aperture width of the first aperture is less than or equal to its circumferential width.

7. The tightening device according to claim 1, wherein the tightening lever exhibits the connecting element.

8. The tightening device according to claim 7, wherein the connecting element has been formed in one piece with the tightening lever.

9. The tightening device according to claim 7, wherein the tightening lever exhibits a sheet-metal shaped part.

10. The tightening device according to claim 1, wherein a reciprocating device operatively connected to the tightening bolt exhibits the coupling element.

11. A steering column for a motor vehicle, comprising:
a supporting unit, by which a servo unit is held in adjustable manner; and
a tightening device according to claim 1, which exhibits a tightening bolt, capable of being rotated about its tightening axis, which interacts with a reciprocating device which has been designed for dis-engageable bracing of the supporting unit with the servo unit by rotation of the tightening bolt which is connected in torsion-locked manner to a tightening lever via a coupling element and a connecting element.
